(19) United States
(12) Patent Application Publication
(10) Pub. No.: US 2009/0255214 A1
(43) Pub. Date: Oct. 15, 2009

(54) Closing device for applying screw tops to containers

(75) Inventors: Gerd Schüssler, Obernburg (DE); Stefan Pedall, Karlstein (DE)

Correspondence Address: HARNESS, DICKEY & PIERCE, P.L.C., P.O. BOX 828, BLOOMFIELD HILLS, MI, 48303, US

(73) Assignee: Alcoa Deutschland GMBH, Worms (DE)

(21) Appl. No.: 11/991,125

(22) PCT Filed: Aug. 25, 2006
(86) PCT No.: PCT/EP2006/008345

§ 371 Date: Feb. 27, 2008

(30) Foreign Application Priority Data
Sep. 9, 2005 (DE) 102005044368.0
Nov. 12, 2005 (DE) 102005054076.7

(51) Int. Cl. B67B 3/20

(52) U.S. Cl. 53/331.5

(57) ABSTRACT

Proposed is a closing device (1) for applying screw tops to containers, in particular beverage bottles, comprising a coupling (5) which transmits a torque from a drive unit to a screw top, the drive unit comprising a drive rotor and an output rotor as well as a torque-transmitting device having at least one magnet and a hysteresis material which interacts with same, or at least one additional magnet. The closing device (1) is characterized by at least one sensor (9) which detects the relative position between the drive rotor (21) and the output rotor (23).

The invention relates to a closing device for applying screw tops to containers, in particular beverage bottles, according to the preamble of claim 1.

Closing devices of this type, i.e., having a magnetic coupling for transmitting a torque from a drive unit to a screw top, are known. In particular for the application of screw tops to containers designed as beverage bottles, it is important to ensure the highest product safety. In the field of capping technology servodrives are used which allow the entire capping process to be controlled, monitored, and documented. However, it has turned out that the purchase, adjustment, and maintenance of such drives entails great expense and effort.

The object of the invention, therefore, is to provide a closing device which ensures a reliable capping procedure and thus offers the opportunity for optimal control and documentation of the entire capping process in order to ensure high product safety through process control.

This object is achieved by a closing device having the features stated in claim 1, and is characterized in that at least one sensor is provided which detects the relative position between a drive rotor and an output rotor of a magnetic coupling for the closing device, thus enabling information concerning the capping procedure to be obtained relatively easily.

One particularly preferred exemplary embodiment of the closing device is characterized in that at least two sensors are provided, thus allowing the relative position between the drive rotor and the output rotor to be detected with respect to the axial orientation and also with respect to the rotary position of the rotors relative to one another. In this manner it is possible to accurately collect a large amount of data concerning the capping process.

Also preferred is an exemplary embodiment of the closing device which is characterized by a signal processing device which processes the data from at least one sensor. This provides the opportunity to prepare the data for later use directly at the site of generation.

One particularly preferred exemplary embodiment of the closing device is characterized in that the closing device includes a transmitter for the wireless transmission of data from the at least one sensor, which allows transmission to a receiver. The data obtained from the at least one sensor may thus be transmitted in a contactless manner from the closing device to a data evaluation unit.

In a further preferred exemplary embodiment, the closing device has a power transmission unit. This allows power to be transmitted, preferably in a contactless manner, to the closing device and thus to supply the components thereof with power.

One particularly preferred exemplary embodiment of the closing device is characterized by an internal power supply for the electronic elements provided by a generator that is integrated into the closing device, preferably into the coupling thereof. In particular when the internal power supply has a capacitor, or more preferably a battery, the power may be stored. When such an autonomous closing device is used in conjunction with a capping machine, the evaluation unit may detect the closing device when it is in a static state, i.e., without rotation in the region of the coupling, due to the fact that the transmitter for the closing device is provided with power from the internal power supply and is able to transmit signals to the evaluation unit without the transfer of external energy.

One further particularly preferred exemplary embodiment of the closing device is characterized in that the at least one sensor is designed as a magnetic field sensor. Such sensors allow a particularly compact design.

In a further preferred exemplary embodiment of the closing device, the sensor is used to detect mechanical strain, and is preferably designed as a strain gauge.

In a further preferred exemplary embodiment of the closing device, the closing device includes an optical sensor. The optical sensor is able to detect deformations in a contactless manner at high resolution, and thus to provide precise data.

Further designs are stated in the remaining subclaims.

The invention is explained in greater detail below with reference to the drawings, which show the following:

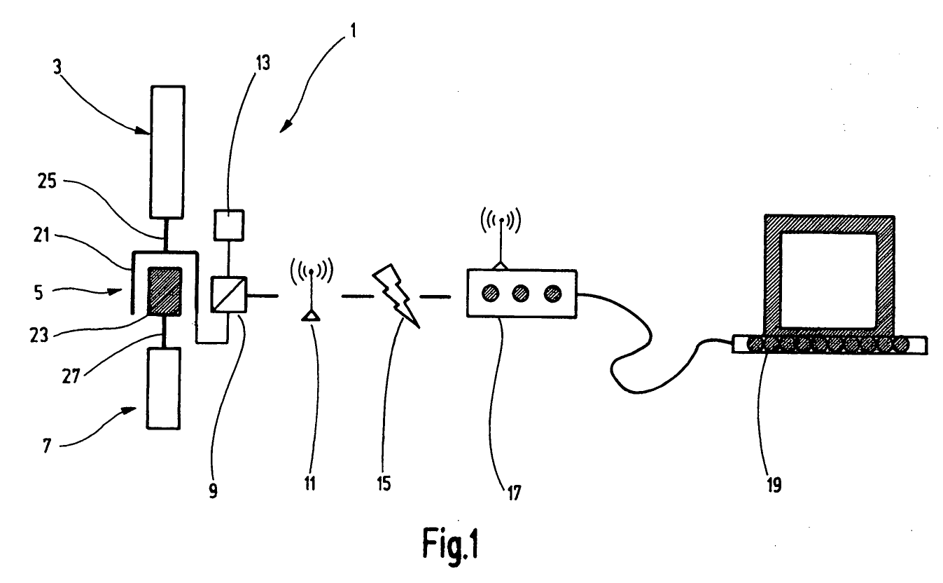

FIG. 1 shows a schematic diagram of a closing device having contactless data transmission and evaluation;

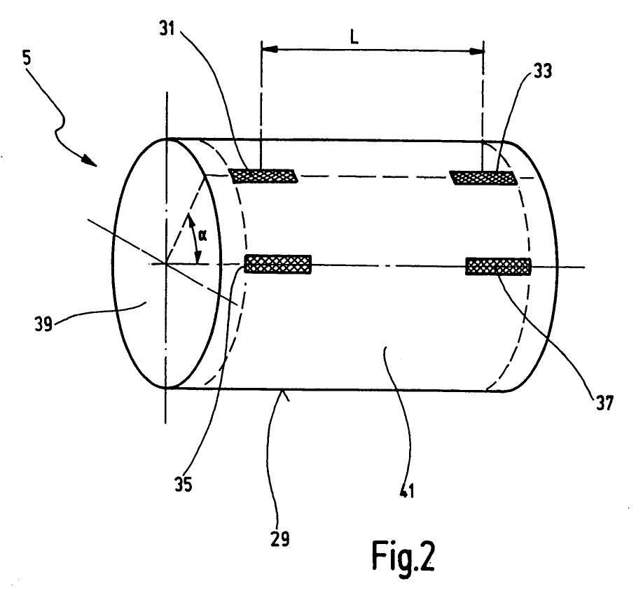

FIG. 2 shows a schematic diagram of a portion of a coupling in a first exemplary embodiment of the closing device;

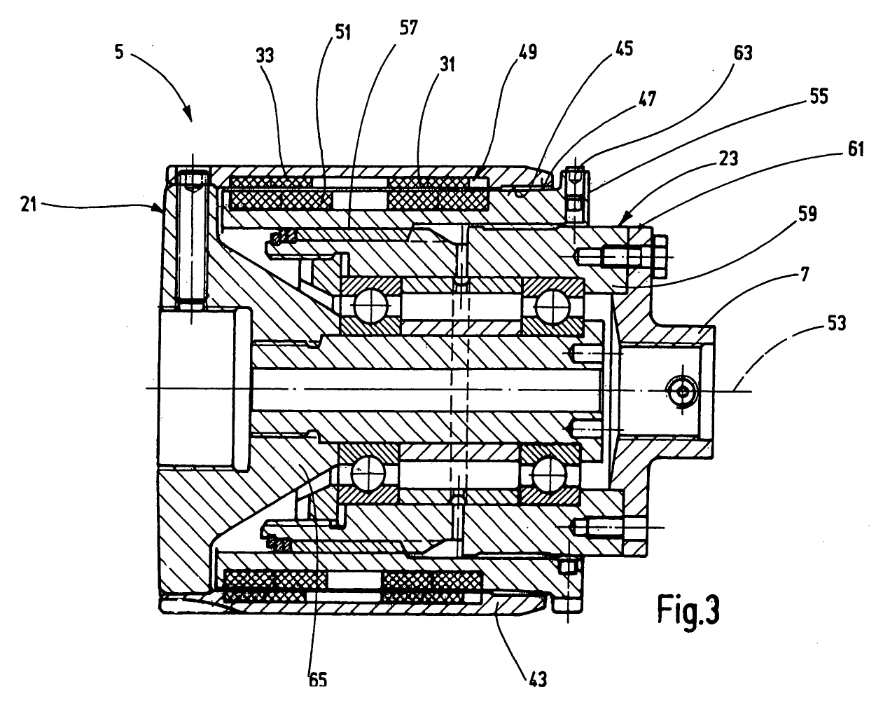

FIG. 3 shows a longitudinal section of a first exemplary embodiment of the coupling for a closing device; and

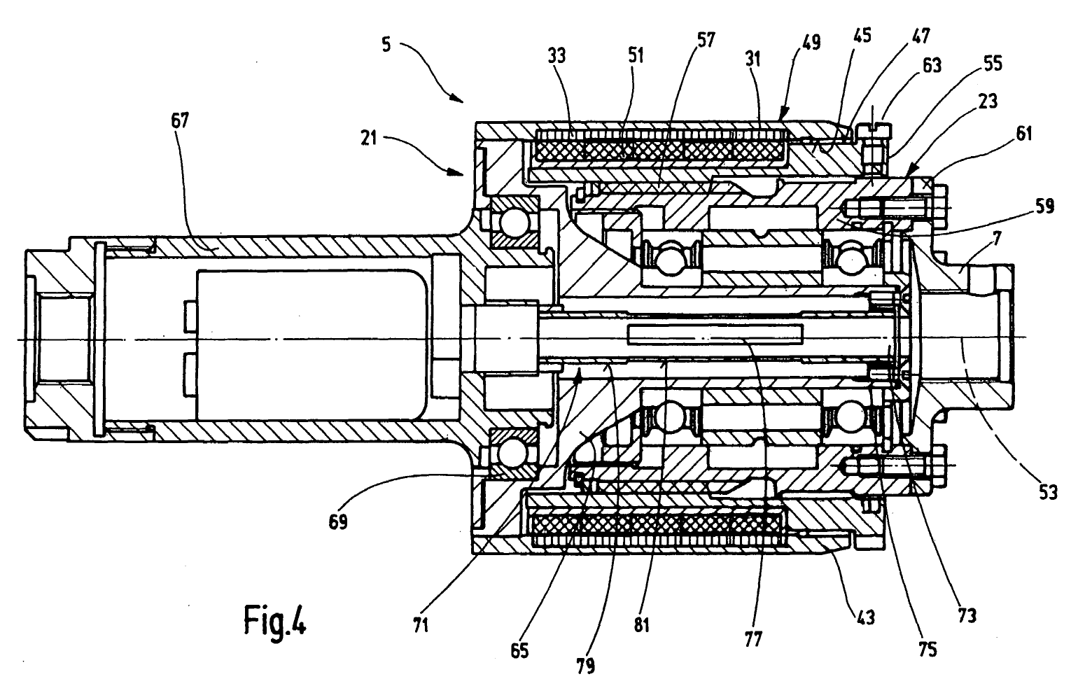

FIG. 4 shows a longitudinal section of a second exemplary embodiment of the coupling for a closing device.

The schematic diagram according to FIG. 1 shows a closing device 1 comprising a drive unit 3, a coupling 5, and an output flange 7. The output flange accommodates an adapter which is able to detect variously designed screw tops of containers, in particular beverage bottles. However, the output flange 7 may also be designed so that it can be used directly for applying screw tops to containers, i.e., to detect screw tops without use of an adapter.

The closing device 1 also has at least one sensor 9 and at least one transmitter 11, as well as a signal processing device 13.

All of the referenced elements of the closing device 1, but generally with the exception of the drive unit 3, are integrated into the closing device 1, which due to the current options for miniaturization of the individual elements comprising the sensor 9, transmitter 11, and signal processing device 13 may have a very compact design.

The data detected in the closing device 1 are transmitted by the transmitter 11 via a contactless data transmission path 15 to a receiver 17 for a data evaluation unit. This data evaluation unit may be accommodated in a control panel or may be a part of a PC. At least one transmitter/receiver unit may be associated with each sensor, and at least one sensor may be associated with each transmitter/receiver unit.

FIG. 1 shows that in the present exemplary embodiment the coupling 5 has a drive rotor designed as an outer rotor 21, and has an output rotor designed as an inner rotor 23. The configuration of the inner and outer rotors may be exchanged. In the exemplary embodiment illustrated, the outer rotor 21 is coupled to the drive unit 3 via a drive shaft 25. It is also possible to integrate a drive assembly into the closing device 1. In this case the inner rotor 23 is connected to the output flange 7 via an output shaft 27.

Since the coupling 5 is implemented as a magnetic coupling, a torque introduced into the outer rotor 21 is transmitted to the inner rotor 23 via magnetic forces. The magnetic coupling may be designed as a hysteresis coupling or also as a synchronous coupling. A hysteresis coupling is preferably provided to avoid oscillations in the closing device. Namely, it has been found that oscillations occur when magnetic closing heads are used to achieve the necessary tightening torque for securely closing beverage bottles. The phenomenon occurs in particular with magnetic synchronous couplings, which, depending on the number of magnetic poles used, convey a magnetic force for transmission of a torque to the beverage bottle to be closed. Oscillations result when the magnetic force breaks off during the capping process. Capping machines having such closing devices have proven to be disadvantageous, in particular for plastic bottles made of polyethylene terephthalate (PET). To avoid such oscillations, hysteresis couplings have been developed which are likewise based on magnetic force coupling but are characterized in that in that they apply a constant closing torque so that oscillations do not occur when the magnetic force breaks off.

The at least one sensor 9 is designed in such a way that it detects the position of the outer rotor 21 relative to the inner rotor 23. It may be provided that the sensor 9 detects only the axial orientation of the inner rotor 23 relative to the outer rotor 21. In this context, “axial orientation” is understood to mean that the configuration of the inner rotor 23 with respect to the outer rotor 21 is observed in the direction of the drive shaft 25 or output shaft 27.

The at least one sensor 9 may be designed in such a way that it detects the rotational position of the inner rotor 23 relative to the outer rotor 21.

It is preferred that the axial orientation as well as the rotational position of the two rotors relative to one another are detected.

The schematic diagram according to FIG. 1 clearly shows that the inner rotor 23 may be inserted into the outer rotor 21, at least in places.

The coupling 5, which is designed as a magnetic coupling and thus transmits a torque from the drive unit 3 to the output flange 7 and thus to a screw top of a container, has a torque-transmitting device which for realizing a hysteresis coupling has at least one magnet, and hysteresis material which interacts with same. The at least one magnet may be provided at the outer rotor 21, and the hysteresis material may be provided at the inner rotor 23. The at least one magnet is preferably situated at the inner surface of the outer rotor, and the hysteresis material is situated on the outer surface of the inner rotor. A ring made of hysteresis material which extends in the circumferential direction of the inner rotor 23 may be provided at this location. The extension of the at least one magnet and of the hysteresis material as viewed in the axial direction may be adapted to the transmitting forces, i.e., to the torque which acts on the screw top.

The discussion of the hysteresis coupling clearly indicates that for the function thereof it is irrelevant whether the at least one magnet is provided on the outer rotor or the inner rotor, the hysteresis material then being respectively provided on the inner rotor or the outer rotor. In addition, the hysteresis coupling may be designed as a synchronous coupling by replacing the hysteresis material with at least one magnet.

Hysteresis couplings and synchronous couplings are basically known, and therefore are not further discussed.

The axial orientation of the inner rotor 23 relative to the outer rotor 21 may be adjusted. In a preferred embodiment of the coupling 5, the inner rotor 23 has a ring which is a part of the torque-transmitting device and which comprises at least one magnet or hysteresis material, in the present exemplary embodiment, a hysteresis ring. This ring may be displaced on the inner rotor 23 as viewed in the axial direction. The ring is preferably provided with an internal thread which meshes with an external thread on the base body of the inner rotor 23. When the ring is rotated, it is also displaced in the axial direction relative to the base body of the inner rotor, and the hysteresis ring is thus displaced on the ring relative to the at least one magnet for the outer rotor.

As the result of an axial displacement of the inner rotor 23, i.e., of the ring for the inner rotor 23 relative to the inner rotor in this case, the overlap of the at least one magnet in the outer rotor with respect to the hysteresis ring for the inner rotor is changed, resulting in a change of the effective magnetic force coupling and also of the torque that can be transmitted by the coupling 5.

The present discussion also clearly indicates that for the function of the coupling it is irrelevant whether the at least one magnet is situated on the outer surface of the inner rotor 23 or in the ring associated with same, or whether the hysteresis ring is situated at the inner surface of the outer rotor 21 or vice versa.

The position of the inner rotor 23 relative to the outer rotor 21, as viewed in the axial direction, is detected by the at least one sensor 9. The signal generated by this senor is preferably processed by the signal processing device 13. The transmitter 11 sends the output signal from the sensor 9 or from the signal processing device 13 in a contactless manner to the receiver 17, thus allowing further processing in the data evaluation unit 19.

A screw top may be applied to the container opening when a torque is developed by the drive unit 3 and transmitted via the coupling 5 to the output flange 7. When the screw top has reached a predetermined position on the external thread associated with the container opening, e.g., when the opening of the container achieves a closure of the screw top, the torque increases in the threaded connection between the screw top and the container. When a preset value is exceeded in the coupling 5, the magnetic force coupling yields to the coupling, thus enabling the outer rotor 21, which acts as a drive rotor, to continue rotating relative to the inner rotor 23, which acts as an output rotor, without the screw top being rotated. The preset torque of the coupling 5 continues to be applied at a constant rate. It is noted in particular that no oscillations occur when a hysteresis coupling is used. The mechanical losses from the coupling are converted to heat and released to the surroundings.

FIG. 2 shows a schematic diagram of a portion of a coupling 5 in an exemplary embodiment of the closing device 1. In this case the inner surface of the outer rotor 21 or the outer surface of the inner rotor 23 is indicated by a cylindrical lateral surface 29. At least one first magnet 31 is situated in the region of the cylindrical lateral surface 29. In the present case this magnet is indicated by a rectangle aligned in the direction of the longitudinal axis of the cylindrical lateral surface 29. A second magnet 33 is located at a distance L from the first magnet 31 as viewed in the axial direction of the cylindrical lateral surface 29.

The present exemplary embodiment of the portion of the coupling 5 has a third magnet 35 located at a distance from the first magnet 31 as viewed in the circumferential direction of the cylindrical lateral surface 29. A fourth magnet 37 is located at a distance from the third magnet 35 as viewed in the axial direction of the cylindrical lateral surface 29, and is the same distance from the second magnet 33 as viewed in the circumferential direction. The distance of the first magnet 31 to the third magnet 35, and of the second magnet 33 to the fourth magnet 37, measured in the circumferential direction is indicated by an angle a at the end face 39 of the cylindrical lateral surface 29.

The distances measured in the circumferential and longitudinal directions as well as the number of magnets 31, 33, 35, and 37 may be modified to various applications, e.g., modified to the torques to be transmitted by the coupling 5.

The four magnets are situated in a region of an imaginary annular surface 41. The magnets 31, 33, 35, 37 situated on the cylindrical lateral surface 29 interact with hysteresis material of the corresponding other rotor of the coupling 5. As stated above, this hysteresis material is preferably provided in an annular configuration on the inner surface of the outer rotor 21 or on the outer surface of the inner rotor 23, i.e., on the exterior of the associated ring. The extension of the height of the annular surface 41 measured in the axial direction is coordinated with the corresponding measured height of the annularly configured hysteresis material. It is preferred that an axial displacement of the ring for the inner rotor 23 relative to the inner surface of the outer rotor 21 causes a change in the overlap of the annular surface 41 of the annularly configured hysteresis material, i.e., a change in the magnetic forces and of the desired torque to be transmitted by the coupling 5.

At least one sensor is provided in the region of the annularly configured hysteresis material which responds to the magnetic field of magnets 31 through 37. Sensors of this type are able to detect their position in the magnetic field associated with magnets 31, 33, 35 and 37 and detect changes in the magnetic field. A torque value is associated with a detected position of a sensor via a calibration process. By means of the at least one sensor it is possible to detect only the position of the at least one magnet relative to the annular hysteresis material as viewed in the axial or circumferential direction. By means of the corresponding design of the sensors and/or by use of at least two sensors, the relative position of the at least one magnet with respect to the annular hysteresis material, as viewed in the axial as well as the circumferential direction, may be detected.

A change in the overlap between the annular surface 41 together with magnets 31, 33, 35, and 37 relative to the annular hysteresis material may be detected by the at least one sensor. If a relative rotation occurs between the at least one magnet and the annular hysteresis material during a capping procedure, this may also be detected by the at least one sensor. As previously stated, it is also possible to detect both relative positions as viewed in the axial and circumferential directions. It is expressly noted once again that the hysteresis material need not necessarily have an annular configuration. It is also possible to provide a surface composed of individual elements made of hysteresis material in order to generate magnetic forces by use of the at least one magnet.

FIG. 3 shows a longitudinal section of a first exemplary embodiment of the coupling 5 for a closing device 1. Identical parts are designated by the same reference numerals, so that reference is made to the preceding description.

The coupling 5 illustrated in FIG. 3 has an outer rotor 21 which acts as a drive rotor, and an inner rotor 23 which acts as an output rotor. As shown in the schematic diagram according to FIG. 1, the outer rotor 21 has a cylindrical shell 43 which encloses the inner rotor 23 in places in the axial direction. The inner rotor is thus inserted partially, in the present case practically entirely, into the outer rotor 21. As stated above, the drive side and output side may be exchanged with one another on the coupling 5.

At least one magnet or hysteresis material is provided on the inner surface 45 of the shell 43. Hysteresis material or at least one magnet is correspondingly provided on the outer surface 47 of the inner rotor 23. In any case, the torque-transmitting device 49 discussed in detail above is implemented in a region of the shell 43 and the outer surface 47 of the inner rotor 23.

In the following discussion it is assumed by way of example that at least one magnet is provided at the inner surface 45 of the shell 43. As an example, in this case the first magnet 31 and the second magnet 33 are illustrated which were also described with reference to FIG. 2. Hysteresis material 51 is situated opposite from these magnets 31, 33. Clearly shown is the overlap of the regions in which the at least one magnet and the hysteresis material are located, thus allowing a torque to be transmitted from the outer rotor 21 to the inner rotor 23.

In order to change the overlap of the elements of the torque-transmitting device 49 in the axial direction, i.e., viewed in the direction of the center axis 53 of the coupling, the hysteresis material 51 is not fixedly connected to the inner rotor 23, but instead is supported so as to be displaceable in the axial direction, thereby realizing an actuating device. Clearly shown here is the above-mentioned ring 55, which is coupled to the base body 59 of the inner rotor 23 via a threaded device 57. Rotation of the ring 55 relative to the base body 59 causes the ring to be displaced on the circumferential surface 61 of the base body 59 in the direction of the center axis 53, i.e., in the axial direction.

After the ring 55 has been rotated by the desired degree it may be fixed in place by a securing element, in this case a screw 63, thus avoiding unintentional rotation.

The outer rotor 21 has a bearing journal 65 which projects into the sleeve-shaped inner rotor 23 and upon which the inner rotor 23 is supported so as to be rotatable in the axial direction, i.e., in the direction of the center axis 53, but also fixedly secured.

The base body 59 of the inner rotor 23 thus remains stationary relative to the outer rotor 21 as viewed in the axial direction, whereas a rotation of the ring 55 causes the base body to move relative to the shell 43 of the outer rotor 21 in the axial direction. The relative motion in the axial direction changes the overlap of the elements of the torque-transmitting device 49, and thus changes the maximum torque which can be transmitted by the coupling 5.

By use of the at least one sensor, which in the present exemplary embodiment is designed as a magnetic field sensor, the position of the sensor relative to the magnetic field of the at least one magnet 31 may be detected. The output signal from the sensor thus changes when the ring 55 is rotated and displaced in the axial direction. Such a sensor may thus be used to adjust and specify the maximum torque which may be transmitted by the coupling 5.

When the described coupling 5 is used, the inner rotor 23 rotates until a screw top is securely screwed onto the opening region of a container. When the maximum transmittable torque is reached the inner rotor 23 stops, even if the outer rotor 21 is still rotating. In this case the at least one sensor designed as a magnetic field sensor may detect the relative rotation of the outer rotor 21 relative to the inner rotor 23, and thus may detect the relative position of the two rotors with respect to one another as viewed in the circumferential direction.

The relative position of the two rotors with respect to one another may be detected in both the axial direction and the circumferential direction by use of specially designed sensors or by the selection of two magnetic field sensors.

The torque from a drive unit 3 (not illustrated here) is introduced into the outer rotor 21 from the left and transmitted by the torque-transmitting device 49 to the inner rotor 23 and thus to the output flange 7 thereof. If the output flange does not engage with a screw top, or if the screw top is not initially screwed onto the opening region of a container, the outer rotor 21 and the inner rotor 23 rotate synchronously. When the maximum transmittable torque from the coupling 5 is reached the inner rotor 23 stops, as previously stated, while the outer rotor 21 continues to rotate.

In the illustration in FIG. 3 the representations of the at least one sensor, the transmitter 11, and the signal processing device 13, described above with reference to FIGS. 1 and 2, have been omitted for simplicity.

The closing device 1, in particular the coupling 5, may be provided with a power transmission unit by means of which power may be transmitted to the closing device 1 or the coupling 5. Induction loops, solar cells, or the like are known by means of which power may be transmitted to rotating parts. Contactless power transmission is thus preferably realized. The power is used to supply the electrical or electronic components of the coupling 5 with power, and to allow contactless data transmission to a data evaluation unit 19.

However, it is also possible to provide an internal power supply. For example, a battery may be inserted into the coupling 5 to supply the electrical or electronic components with power, and also for a longer extension of the closing device 1 to allow transmission of data, for example identification data, which preferably are uniquely associated with the closing device 1.

An internal power supply may also be realized by providing coils on the outer rotor 21 and on the inner rotor 23 to form a generator. When a relative rotation occurs between the two rotors, the outer rotor 21 is caused to rotate relative to the stationary inner rotor 23 during a capping procedure, thus generating power which is stored in a suitable power storage means, for example a capacitor but preferably a battery, and which is available for operating the closing device 1, even when it has not been used for an extended period. External power transmission may be omitted in this case as well. The replacement of spent batteries is also omitted. If power is to be supplied only intermittently for brief periods, it is sufficient for the internal power supply to charge a capacitor.

Altogether, it is noted that in the present exemplary embodiment of a coupling 5 an axial displacement of the elements of the torque-transmitting device 49 as well as a relative rotation between the outer rotor 21 and the ring 55, i.e., the inner rotor 23, may be detected by use of the ring 55.

FIG. 4 shows a further exemplary embodiment of a coupling 5 for a closing device. Here as well, identical parts are designated by the same reference numerals, so that reference is made to the preceding description.

The coupling 5 once again has an outer rotor 21 and an inner rotor 23 which is provided with the above-described ring 55 for an actuating device. As described above, this ring provides the overlap of the elements of the torque-transmitting device 49 as viewed in the axial direction, i.e., in the direction of the center axis 53.

The outer rotor 21 accommodates the inner rotor 23 in places, and encloses same with the cylindrical shell 43. The bearing journal 65 also projects into the interior of the inner rotor 23, which is rotatably supported on its outer side via a suitable bearing.

The exemplary embodiment illustrated here differs from that shown in FIG. 3 in that the torque introduced by the drive unit 3 (not illustrated here) into the outer rotor 21 is not directly transmitted to the bearing journal 65 and the shell 43. In this instance a drive journal 67 into which the drive torque is introduced is mounted so as to be rotatable relative to the bearing journal 65. In the present case a suitable bearing unit 69 is provided between the end of the drive journal 67 terminating inside the bearing journal 65 [and the bearing journal]. The torque introduced into the drive journal 67 is transmitted to a measuring shaft 71 mounted to the end of the drive journal in a rotationally fixed manner, the opposite end 73 of the measuring shaft being connected in a rotationally fixed manner to the end 75 of the bearing journal 65 facing away from the drive journal 67.

When a torque is introduced via the drive journal 67 into the measuring shaft 71, the bearing journal 65 rotates together with the shell 43 which is connected thereto in a rotationally fixed manner. The torque-transmitting device 49 causes the inner rotor 23 to rotate synchronously with the outer rotor 21, provided that no load torque is present at the output flange 7 which is greater than the maximum transmittable torque from the coupling 5.

When a load torque is present at the output flange 7 the measuring shaft 71 is rotated within itself. The measuring shaft 71, in this case designed as a hollow shaft, is preferably weakened, and also has at least one weakening region 77, in this case an opening or recess, extending in the longitudinal direction. This causes a greater rotation of the two ends of the measuring shaft 71 relative to one another at a given torque, thus allowing better detection of the mechanical deformation of the measuring shaft 71.

A rotation of the measuring shaft 71 is detected by means of a sensor which detects a mechanical deformation, or by means of an optical sensor. In the exemplary embodiment illustrated here, at least one groove 81 extending in the longitudinal direction, i.e., in the direction of the center axis 53, is provided in the circumferential surface 79 of the measuring shaft 71. An annular groove may also be provided. At least one strain gauge is introduced into at least one groove 81. Two oppositely situated strain gauges are preferably provided.

FIG. 4 shows that the measuring shaft 71 is situated inside the bearing journal 65, and therefore also inside the inner rotor 23. The coupling 5 thus has a very compact design, particularly in the longitudinal direction. In addition, the measuring shaft 71 is situated in a protected manner inside the coupling 5.

It is clear that the drive and output sides of the coupling 5 may be easily exchanged with one another, and/or the coupling 5 on the drive side and on the output side may have an identical design, the same as for conventional couplings. Existing capping machines may thus be easily retrofitted with the closing device 1 described herein. It is only necessary to provide a data processing device 19, as explained with reference to FIG. 1. Since the data transmission occurs in a contactless manner via a wireless data transmission path 15, no wiring is necessary between the retrofitted capping machine and the data evaluation unit 19.

Besides via electromagnetic waves, in principle the contactless data transmission may also occur by means of optical or acoustic signals, such as via infrared, ultrasound, or the like, also via Bluetooth technology, e.g.

The closing device 1 is preferably designed in such a way that it emits a unique code, thus allowing the data sent to the data evaluation unit 19 to be uniquely assigned. With an appropriate design of the data evaluation unit 19, multiple closing devices, even thirty or more, may be used and distinguished by the data evaluation unit 19.

Here as well, it is seen that the overall system comprising closing devices and data evaluation units may be varied within a very broad range. The closing device may have a sensor, signal processing device, and transmitter, as well as multiple sensors associated with a signal processing device, or multiple signal processing devices and multiple transmitters. It is thus possible to freely assign the number of sensors, signal processing devices, and transmitters. In addition, multiple data evaluation units may be used with which a number of closing devices are associated.

When a closing device 1 of the type described herein is used by means of the at least one sensor designed as a magnetic field sensor or strain gauge, optical sensor, or the like in the static state, i.e., with the coupling 5 idle, data may be transmitted to a data evaluation unit 19 due to the fact that the internal power supply reserves power, generated by a battery or by the internal generator, and stores it in a storage means, which allows signals to be sent via the transmitter 11.

As a result of the displacement, as viewed in the axial direction, of an element of the torque-transmitting device 49 by means of the ring 55 for the inner rotor 23, the maximum transmittable torque from the coupling 5 may be adjusted and scanned even when the coupling 5 is idle. The differing overlap of the elements of the torque-transmitting device 49 cannot be detected by the strain gauge described with reference to FIG. 4; rather, it is detected by use of the magnetic field sensors described here. In principle, however, these magnetic field sensors could also be used for a coupling 5 having a strain gauge, as described with reference to FIG. 4.

When the closing device 1 is used, in both of the exemplary embodiments described with reference to FIGS. 3 and 4 a relative motion between the outer rotor 21 and the inner rotor 23 may be detected and transmitted to the data evaluation unit 19.

The data evaluation unit 19 may thus easily detect the adjusted torque for a coupling 5, namely, the axial relative position of the elements of a torque-transmitting device 49. It is therefore also possible to detect the position of the ring 55 for the inner rotor 23 relative to the shell 43 of the inner rotor 23.

Since in addition a rotational displacement of the outer rotor 21 relative to the inner rotor 23, or vice versa, may be detected by the use of magnetic field sensors, the actual torque which is transmitted from a drive unit 3 to an output flange 7 during a capping procedure may be determined.

Lastly, it is possible to determine the angular position of the closing head provided on the output flange 5 with respect to the outer rotor 21 during the capping procedure for a container, but also upon placement of a screw top on a container.

For a closing device 1 of the type described herein, the actual torque, i.e., the instantaneously transmitted torque, [and] the rotational angle position of the rotors of a coupling 5 relative to one another may be determined and stored over time. Thus, a wealth of data may be stored and documented over the entire capping process, resulting in very high product safety.

Torques may be detected within specific time windows during the capping process. If a high torque should be determined at the very beginning of a capping procedure, i.e., overrotation of the drive rotor relative to the output rotor, a conclusion may be drawn that this is the result of a misaligned screw top or a defective external thread on a container on which the screw top is to be placed. In addition, if a load torque cannot be detected after a specified time period, i.e., a relative rotation between the outer rotor 21 and inner rotor 23 cannot be determined, the following conclusions may be drawn: either a screw top was not picked up by the output flange 7 or closing head connected at that location, or the container to be capped is missing or tipped over.

By use of the results obtained from the data evaluation unit 19 it is also possible to detect malfunctions during the capping process, or also to detect a defect in the coupling 5.

It has also been shown that in particular magnetic field sensors may be used for detection and axial displacement of the elements of a torque-transmitting device 49, as well as for rotational displacement of these elements relative to one another.

The descriptions of the closing device 1 and the associated coupling 5 clearly indicate that these have a drive rotor and an output rotor. The exemplary embodiment illustrated in the figures has a coupling 5 with an outer rotor 21 which encloses an inner rotor 23 at least in places.

However, the coupling may also be designed as a multidisk clutch, disk clutch, or the like. For example, two disks may be provided essentially coaxially at a distance from one another, one disk being used as the drive rotor and the other disk being used as the output rotor. At least one magnet may be provided on one of the disks, and hysteresis material or at least one additional magnet may be provided on the other disk. The at least one magnet and the hysteresis material are preferably provided on the mutually facing surfaces of the disks, whereby the hysteresis material may be provided with an annular configuration on the disk surface. By use of suitable adjusting devices the at least one magnet for the oppositely situated disk may be adjustable in the radial direction in order to vary the overlap between the hysteresis material and the at least one magnet, and thus to vary the transmittable torque.

Of course, multiple rings which are composed of hysteresis material and coaxially aligned on the disk surface may also be provided on a disk. On the oppositely situated disk at least one magnet is then associated with each ring. Lastly, it is also possible to provide at least one magnet on both disks, and here as well the magnet may be radially adjustable on at least one of the disks to allow the transmittable torque to be specified.

The distance between the disks and/or their relative rotation may be detected by suitable sensors. Magnetic field sensors as described above may be used here as well.

The disks are provided with shafts so that a drive torque may be introduced into a disk and an output torque may be applied by the other disk. Sensors may be integrated into the shafts to allow detection of the drive torque and/or output torque. It is also possible to use hollow shafts, which may also have weakening regions. In this regard reference is made to the discussion for FIG. 4.

The discussions also clearly indicate that, besides the sensors described herein which are used for detecting the relative position between the drive rotor and output rotor, and/or for detecting the drive torque or load torque, sensors may also be used which detect other physical variables, e.g. the temperature, rotational speed of the drive rotor and/or output rotor, or pressures acting on the closing device, such as the contact pressure from the output flange or the like. Lastly, sensors may also be used which detect the chemical composition of the gases present inside or outside of the closing device.

Here as well, the same as for the above-mentioned sensors, signal processing devices may be provided if necessary, whereby such a device may be associated with one or more sensors. It is also possible to associate with one or more sensors a respective transmitter which transmits the data to one or more suitable data evaluation units.

It is particularly advantageous when in the implementation of the closing device 1 the various electrical and/or electronic components, i.e., sensors, signal processing devices, transmitters, and the like are located on the same rotor, and the power supply is also provided on these components in order to avoid power transmission between rotating parts.

1-24. (canceled)

25. A closing device for applying screw tops to containers, comprising:
a drive unit having a drive rotor and an output rotor, the drive unit further having a torque-transmitting device having at least one magnet and a hysteresis material which interacts with the at least one magnet, or at least one additional magnet;
a coupling for transmitting a torque from the drive unit to a screw top, and
at least one sensor which detects the relative position between the drive rotor and the output rotor.

26. The closing device according to claim 25, wherein one of the drive rotor and the output rotor is an outer rotor, and the output rotor or the drive rotor is correspondingly designed as an inner rotor situated in the outer rotor in places.

27. The closing device according to claim 25, wherein the drive rotor and the output rotor are designed as a disk, the disks being provided essentially coaxially and at a distance from one another on separate shafts.

28. The closing device according to claim 25, comprising at least two sensors for allowing the relative position between the drive rotor and output rotor to be detected with respect to the axial orientation and also with respect to the rotary position.

29. The closing device according to claim 25, further comprising at least one signal processing device which processes the data from at least one sensor.

30. The closing device according to claim 25, further comprising at least one signal processing device, in the form of at least one transmitter, for the wireless transmission of data from the at least one sensor to at least one receiver.

31. The closing device according to claim 25, further comprising a power transmission unit for transmitting power to the closing device.

32. The closing device according to claim 31, wherein the power transmission unit is designed for contactless power transmission.

33. The closing device according to claim 25, further comprising an internal power supply.

34. The closing device according to claim 33, wherein the internal power supply has a power generation device, preferably a generator.

35. The closing device according to claim 33, further comprising at least one of a battery and a capacitor.

36. The closing device according to claim 25, further comprising an emergency power supply which supplies power to the power-consuming elements of the closing head during pauses in use.

37. The closing device according to claim 25, wherein the at least one sensor is designed as a magnetic field sensor.

38. The closing device according to claim 25, wherein the at least one sensor is selected from a group including a strain gauge and an optical sensor.

39. The closing device according to claim 38, further comprising a measuring shaft is provided which is associated with the at least one sensor.

40. The closing device according to claim 39, wherein the measuring shaft is situated between the drive unit and the outer rotor.

41. The closing device according to claim 39, wherein the measuring shaft is situated between the inner rotor and the output flange.

42. The closing device according to claim 25, wherein the outer rotor engages with the inner rotor in places.

43. The closing device according to claim 39, wherein the measuring shaft is situated inside the outer rotor.

44. The closing device according to claim 43, wherein the measuring shaft is situated inside the inner rotor.

45. The closing device according to claim 39, wherein the measuring shaft is selected from a group including a solid and a hollow shaft.

46. The closing device according to claim 39, wherein the measuring shaft is a hollow shaft with at least one weakening region.

47. The closing device of claim 46, wherein the weakening region is a recess.

48. The closing device according to claim 25, further comprising an actuating device for adjusting the axial relative position between the at least one magnet and the hysteresis material of the torque-transmitting device.

49. The closing device according to claim 48, wherein the actuating device has a ring.

50. The closing device according to claim 49, wherein the ring is coupled to on of the outer rotor and the inner rotor via a threaded device.
